(19) United States
(12) Patent Application Publication
(10) Pub. No.: US 2014/0053561 A1
(43) Pub. Date: Feb. 27, 2014

(54) AIRCRAFT FUEL CELL SYSTEM, AIRCRAFT AND USE OF A SYNTHETIC FUEL

(71) Applicant: Airbus Operations GmbH, Hamburg (DE)

(72) Inventors: Kan-Ern Liew, Muenchen (DE); Michael Enzinger, Neu-Wulmstorf (DE); Juergen Steinwandel, Uhldingen-Muehlhofen (DE)

(21) Appl. No.: 14/040,974

(22) Filed: Sep. 30, 2013

Related U.S. Application Data
(63) Continuation of application No. PCT/EP2012/001391, filed on Mar. 29, 2012.
(60) Provisional application No. 61/487,685, filed on May 18, 2011.

(30) Foreign Application Priority Data
Apr. 1, 2011 (DE) 10 2011 015 824.3

(51) Int. Cl. F02C 7/22; C01B 3/24

(52) U.S. Cl. CPC F02C 7/22; C01B 3/24
USPC 60/734; 423/648.1; 423/650

(57) ABSTRACT

An aircraft fuel cell system is provided. The system includes a fuel tank, a reactor for generating hydrogen gas from a fuel, a heating apparatus and a fuel cell. The reactor can process a synthetic fuel produced from biomass. The use, in an aircraft, of a synthetic fuel, produced from biomass, for generating a gas that contains hydrogen is also provided.

### CROSS-REFERENCE TO RELATED APPLICATIONS

This is a continuation of International Application No. PCT/EP2012/001391, filed Mar. 29, 2012, which application claims priority to German Patent Application No. 10 2011 015 824.3, filed Apr. 1, 2011, and to U.S. Provisional Patent Application No. 61/487,685, filed May 18, 2011, which are each incorporated herein by reference in their entirety.

### TECHNICAL FIELD

This application pertains to a fuel cell system intended for use on board an aircraft, in particular an airplane, wherein the hydrogen used for operating the fuel cell is produced from a synthetic fuel produced from biomass. Furthermore, the application relates to the use of a synthetic fuel produced from biomass, for producing hydrogen in an aircraft, as well as to an aircraft containing the fuel cell system according to the present disclosure.

### BACKGROUND

Fuel cell systems make it possible to generate electrical energy in a low-emission manner and with high efficiency. There are therefore at present also in airplane engineering endeavors to make use of fuel cell systems for generating the electrical energy required on board an airplane. For example, it is imaginable to at least in part replace the generators currently used for generating power on board, which generators are driven by the main engines or by the auxiliary power unit, by a fuel cell system. Moreover, fuel cell systems may also be used to ensure the emergency power supply of the airplane.

Fuel cells usually comprise a cathode region and an anode region, wherein the latter is separated by an electrolyte from the cathode region. During operation, in the case of fuel cells comprising a proton exchange membrane, also known as a polymer electrolyte membrane (PEM), a reducing agent, usually hydrogen, is fed to the anode of the fuel cell, and an oxidizing agent, for example air, is fed to the cathode of the fuel cell. At the anode, the hydrogen is catalytically oxidized, while producing electrons, to hydrogen ions. The latter reach the cathode region, by way of the electrolyte, wherein in the cathode region they react, with the oxygen fed to the cathode and with the electrons conveyed to the cathode by way of an external current circuit, to form water. Polymer electrolyte membrane (PEM) fuel cells have operating temperatures of up to 100° C. In solid oxide fuel cells (SOFCs) an electrolyte comprising a solid ceramic material is used, which electrolyte is able to conduct negatively charged oxygen ions from the cathode to the anode, while having an insulating effect on electrons. Electrochemical oxidation of the oxygen ions with hydrogen or carbon monoxide thus takes place on the anode side. The operating temperature of solid oxide fuel cells ranges from 500° C. to 1000° C.

In order to minimize pressure losses within the fuel cell, ensure even gas distribution on the electrodes of the fuel cell, and keep the volume flow through the fuel cell as low as possible it is advantageous to feed to the cathode compressed air, i.e. air at a pressure that is above the ambient pressure. DE 10 2008 006 742 describes a fuel cell system which for operating the fuel cell uses the air that in flight operation of an aircraft is brought to a cabin pressure, which is higher than the ambient pressure, by means of an air conditioning system.

Hydrogen used for operating a fuel cell on board the aircraft is either obtained directly from a tank, or is indirectly catalytically produced from a fuel in a reactor, also referred to as a reformer. Kerosene is the fuel used in aircraft for generating hydrogen in the reforming process. Kerosenes are aviation fuels of various specifications, and are predominantly used as aviation turbine fuels. Kerosene is obtained from the uppermost column trays of the middle distillate of crude oil rectification. The main components of kerosene are: alkanes, cycloalkanes and aromatic hydrocarbons having approximately 8 to 13 carbon atoms per molecule. In civil aviation, almost exclusively a kerosene with the specification Jet A-1 is used as an aviation turbine fuel. Although kerosene is a narrow fraction section from the light middle distillate of crude oil refining, it is still a mixture comprising numerous hydrocarbons, wherein the number of compounds comprised in the mixture is further increased by the addition of functional additives in order to attain the respective specification.

During catalytic production of hydrogen from kerosene, as a result of incomplete chemical conversion, coke may form on the catalyst surface of the reformer. During this process, which is also referred to as carbonization or catalyst poisoning, the active surface of the reformer catalyst is reduced, which results in a shorter service life of the reformer.

Other objects, desirable features and characteristics will become apparent from the subsequent summary and detailed description, and the appended claims, taken in conjunction with the accompanying drawings and this background.

### SUMMARY

According to various embodiments, provided is an aircraft fuel cell system in which the service life of the reformer is extended.

In one embodiment, an aircraft fuel cell system is provided. The system includes a fuel tank for a fuel present in a liquid phase, and a reactor for reforming fuel from the fuel tank to a gas that contains hydrogen. The system also includes a heating apparatus for heating the fuel fed to the reactor and a fuel cell. The system includes a fuel feed line for feeding fuel from the fuel tank to the reactor and an outlet line for feeding the gas that contains hydrogen from the reactor to the fuel cell. The reactor is designed for processing, as a fuel, a synthetic fuel made from biomass.

Also provided is a process for generating a gas containing hydrogen in an aircraft comprising feeding synthetic fuel, which is produced from biomass, from a fuel tank to a reactor for reforming fuel, and reforming the synthetic fuel.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIG. 1 shows a fuel cell system according to various embodiments for use in an aircraft.

FIG. 2 shows an aircraft comprising a fuel cell system according to various embodiments.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

Surprisingly, it has been found that with the use of a synthetic fuel made from biomass, for producing hydrogen, the service life of the reformer may be considerably extended. Accordingly, the present disclosure relates to an aircraft fuel cell system (1) comprising a fuel tank (2) for a fuel present in a liquid phase; a reactor (3) for reforming fuel from the fuel tank to a gas that contains hydrogen; heating apparatus (4) for heating the fuel fed to the reactor; a fuel cell (5); a fuel feed line (6) for feeding fuel from the fuel tank to the reactor; an outlet line (7) for feeding the gas that contains hydrogen from the reactor to the fuel cell, wherein the reactor is designed for processing, as a fuel, a synthetic fuel made from biomass.

In the present disclosure, in one example, a liquid hydrocarbon mixture is used as a fuel, which hydrocarbon mixture has been obtained by Fischer-Tropsch synthesis and has been processed by distillation or rectification. The Fischer-Tropsch synthesis is a large-scale process for converting carbon monoxide/hydrogen mixtures (synthesis gas) to liquid hydrocarbons. The synthesis gas used in the Fischer-Tropsch synthesis is generated by pyrolysis of biomass, wherein the biomass, e.g. straw, algae, waste wood or agricultural crops cultivated especially for fuel production, is converted, at temperatures of approx. 200° C. to in excess of 1,000° C., to liquid and gaseous hydrocarbons and finally to synthesis gas.

Another option for producing the fuel comprises obtaining bio oil (e.g. algae oil) by oil extraction from the biomass. The bio oil is subsequently further processed by processes such as catalytic hydrocracking, hydrogenation or transesterification, wherein a mixture, usually of liquid hydrocarbons, is obtained that is then processed, e.g. by distillation and/or rectification, in order to obtain the fuel.

The fuel cell system according to various embodiments is thus operated by a synthetic fuel produced from a biomass, in one example, by means of a biomass-to-liquid method comprising the following: a) pyrolysis of the biomass in order to obtain a carbon monoxide/hydrogen mixture (synthesis gas), b)conversion of the synthesis gas to a mixture of liquid hydrocarbons, and c) processing of the mixture in order to obtain the fuel.

As an alternative, the synthetic fuel is obtained from bio oils, usually by applying a production method comprising: a) extraction of oil from a biomass containing oil, b) processing of the oil by catalytic hydrocracking, hydration or transesterification in order to obtain a mixture of hydrocarbons, and c) processing of the mixture in order to obtain the fuel.

Bio fuels may be produced from biomass or bio oils using a host of different methods, wherein most of these methods comprise the treatment and processing of biological material in order to obtain the desired fuel. One of these methods relates to a biomass-to-liquid (BtL) process, wherein the synthetic fuel is obtained from the biomass by applying the Fischer-Tropsch process, flash pyrolysis or catalytic depolymerization. Another method relates to a gas-to-liquid (GtL) process, wherein a gas obtained biologically (e.g. methane from bacterial decomposition of biological waste) is converted to the desired fuel.

Furthermore, the bio oil of the above-mentioned biomass-to-liquid (BtL) process may also be used as source material. By means of all these production processes a fuel is obtained which due to its synthetic production is essentially free of sulfur and comprises a smaller number of different hydrocarbons, i.e. it is a less complex mixture when compared to commonly used kerosene. With the use of such a synthetic fuel the formation of coke on the reformer catalyst is reduced and the service life of the catalyst is extended.

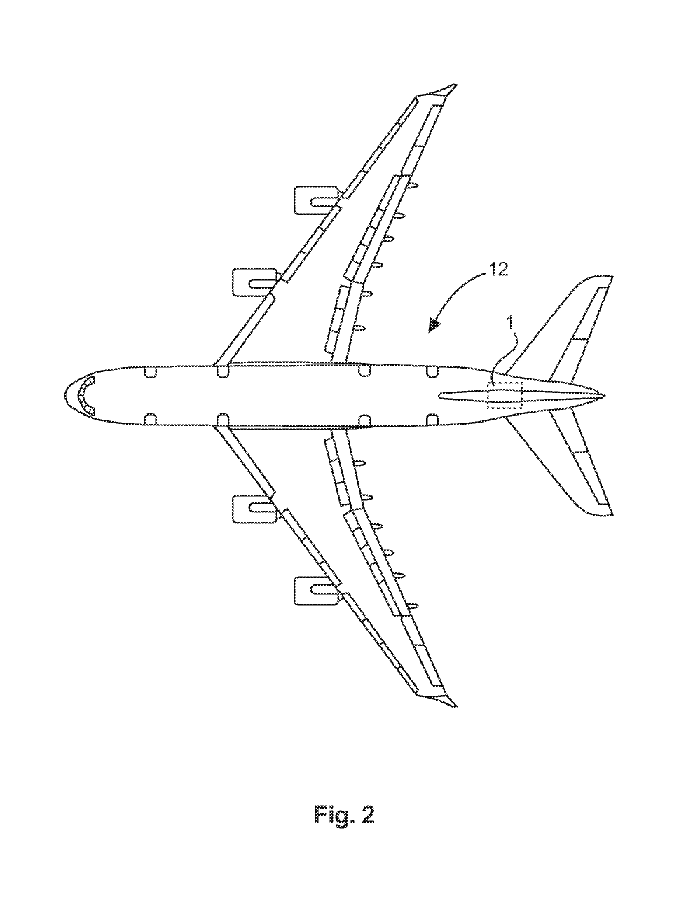

Since in the aircraft fuel cell system according to the present disclosure a fuel other than kerosene is used, the fuel used for operating the fuel cell system may not originate from the tanks that contain the fuel for the engines of an aircraft (12) shown in FIG. 2. Thus, the aircraft fuel cell system according to the various embodiments of the present disclosure differs from a kerosene-operated system not only in that the reactor for reforming fuel must be designed for processing a BtL-fuel, but moreover in that the fuel cell system according to the present disclosure comprises a fuel tank (2) that does not contain the fuel for the engines.

In one exemplary embodiment, the fuel cell system according to the present disclosure comprises a cleaning unit (8) arranged between the reactor (3) and the fuel cell (5). The cleaning unit is used to separate impurities contained in the gas generated in the reactor, which gas contains hydrogen, in particular residual fuel, products such as alcohols that have formed as a result of incomplete oxidation of the hydrocarbons, or hydrocarbons of shorter chain lengths (methane, ethane and the like) that have been produced by cracking. In one embodiment of the fuel cell system according to the present disclosure, these impurities may be fed to an engine (11) and may thus ensure clean combustion of the fuel, i.e. may help to reduce the formation of soot and of nitric oxides.

Since generating, which is carried out in the reactor (3), a gas that contains hydrogen is carried out at relatively high temperatures, the fuel fed to the reactor needs to be heated to the reaction temperature by means of heating apparatus (4).

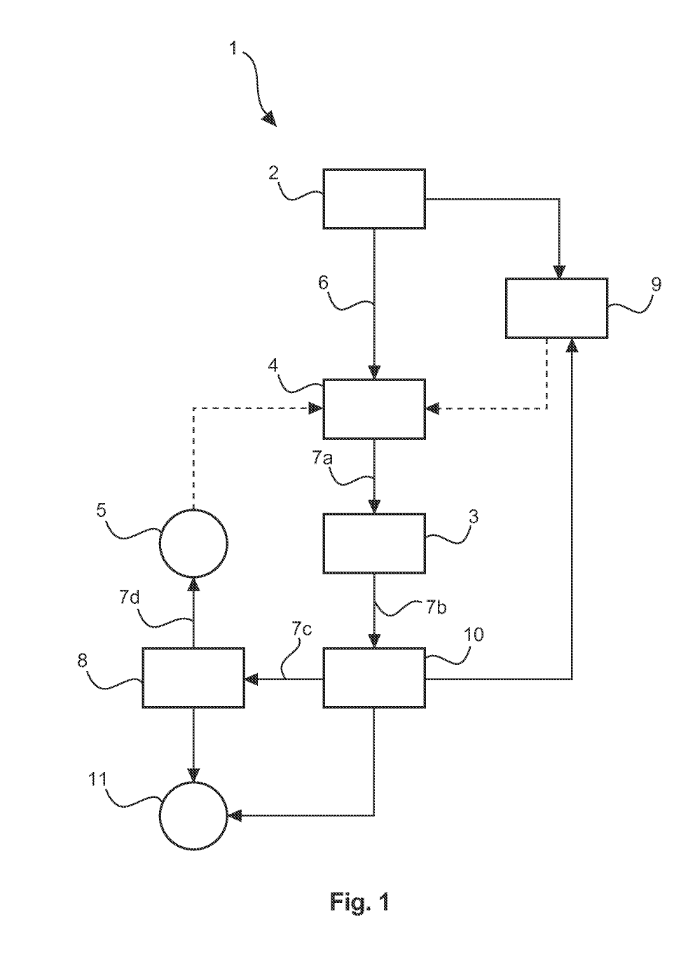

In one example, the fuel cell system according to the present disclosure comprises a burner (9) that is thermally coupled to the heating apparatus (4) (in FIG. 1 indicated by a dashed line), and that is operated by means of the synthetic fuel from the fuel tank and/or by means of the impurities that were separated in the cleaning unit (8) (not shown in FIG. 1). As an alternative or in addition, the heating apparatus may also be supplied in some other way, e.g. with the use of electrical energy. When used in an aircraft with a jet engine, the reactor may advantageously also be heated by bleed air that is available anyway. As an alternative, it is also possible to use exhaust heat from the jet engine and/or from the existing fuel cell. In one embodiment of the fuel cell system according to the present disclosure, the fuel cell is therefore thermally coupled to the heating apparatus (in FIG. 1 indicated by a dashed line) in order to use the heat generated during operation of the fuel cell for the purpose of heating the fuel fed to the reactor.

Various methods may be used for generating the gas that contains hydrogen, in the reactor, by reforming In the fuel cell system according to the present disclosure, the reactor is designed to carry out steam reforming, autothermal steam reforming or catalytic partial oxidation. These reforming methods are generally carried out at a reaction temperature ranging from about 500° C. to about 1,000° C., for example, from about 600° C. to about 700° C., and at a reaction pressure ranging from about 10 bar to about 25 bar.

In the above-mentioned methods a synthesis gas, i.e. a carbon monoxide/hydrogen mixture, arises from the synthetic fuel. In steam reforming the fuel is reacted with water vapor, while in autothermal steam reforming, apart from fuel and water vapor, oxygen is also present in the reaction mixture. The water used in this method originates from any of the following: from water tanks, from the air discharged from the aircraft cabin, from the bleed air, and/or is an electrode reaction product from the fuel cell. DE 10 2008 006 953 describes a fuel cell system in which the water vapor derived from the fuel cell is injected into the combustion chamber of an aircraft engine in order to reduce the combustion temperature and thus the content of nitric oxides in the engine exhaust gases. In the fuel cell system according to the present disclosure the water arising during operation of the fuel cell is then fed to the reactor. The oxygen required for carrying out catalytic partial oxidation or autothermal steam reforming is either obtained from the cabin air, as described in DE 10 2008 006 742, from the bleed air, and/or from the fuel cell, in which said oxygen arises as excess oxygen.

In the above-mentioned methods for reforming the synthetic fuel, the hydrogen is produced with the supply of a suitable oxidizing agent, such as air or water. Producing hydrogen gas by partial dehydration, as described, for example, in DE 10 2005 044 926 is an alternative to this method. During partial dehydration no synthesis gas arises because no oxidizing agent is present in the reaction mixture. Instead, during reforming of the fuel a dehydrated residual fuel arises, which advantageously may be separated from the generated gas that contains hydrogen in a condensation device (10) that is arranged between the reactor (3) and the cleaning unit (8). The dehydrated residual fuel may then be fed to the engine (11) and/or to the burner (9) as a fuel.

In one exemplary embodiment, dehydration is carried out in the supercritical phase of the fuel, as described in WO 2009/074218. In the supercritical phase the fuel is present neither as a liquid nor as a gas; instead, these phases become indistinguishable. This state is attained if both the temperature and the pressure exceed the substance-intrinsic “critical temperature” or the “critical pressure”. The reaction temperature during dehydration is above the critical temperature. In terms of the synthetic fuel used in the present disclosure it has been shown to be expedient if the reaction temperature exceeds about 300° C., for example ranges from about 350° C. to about 500° C., or in one example, ranges from about 400° C. to about 450° C. The reaction pressure usually ranges from about 8 bar to about 25 bar, in one example, from about 10 bar to about 20 bar, and in another example, ranges from about 12 bar to about 15 bar.

When carrying out dehydration, in the reactor, at a comparatively high temperature and a comparatively high pressure, first a mixture of produced hydrogen and dehydrated residual fuel arises. In one embodiment it is provided for this mixture to first flow through a heat exchanger and for separation into a hydrogen stream and a residual fuel stream to take place only subsequently. In an alternative embodiment, dehydration of the fuel and separation of the arising hydrogen from residual fuel take place in one stage, in other words still within the region of the reactor. For this purpose, for example, a so-called membrane reactor may advantageously be used, in which in the reactor interior there is a membrane that is permeable to the arising hydrogen. With this embodiment, too, an improvement is preferred in which the comparatively high temperature of the generated hydrogen gas is utilized in that the hydrogen gas is made to flow through a heat exchanger before being used, for example in order to contribute to pre-heating the fuel fed to the reactor.

While during reforming with the use of an oxidizing agent, synthesis gas arises, during dehydration a mixture of hydrogen and dehydrated residual fuel forms. After separation of the dehydrated residual fuel and of the impurities, either synthesis gas or hydrogen gas is fed to the fuel cell. Consequently, with the use of synthesis gas no polymer electrolyte fuel cell (PEMFC) is used, because the carbon monoxide present in the gas would poison the catalyst. A polymer electrolyte fuel cell may thus be used only if the gas that contains hydrogen, which gas has left the reactor, was obtained by means of partial dehydration of the fuel. Due to the sensitivity of the polymer electrolyte fuel cell to catalyst poisons such as carbon monoxide, generally, a solid oxide fuel cell (SOFC) is used in the fuel cell system according to the present disclosure.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1. An aircraft fuel cell system comprising:
a fuel tank for a fuel present in a liquid phase;
a reactor for reforming fuel from the fuel tank to a gas that contains hydrogen;
a heating apparatus for heating the fuel fed to the reactor;
a fuel cell;
a fuel feed line for feeding fuel from the fuel tank to the reactor; and
an outlet line for feeding the gas that contains hydrogen from the reactor to the fuel cell,
wherein the reactor is designed for processing, as a fuel, a synthetic fuel made from biomass.

2. The aircraft fuel cell system of claim 1, wherein the fuel was produced by
pyrolysis of the biomass in order to obtain a carbon monoxide/hydrogen mixture (synthesis gas),
conversion of the synthesis gas to a mixture of liquid hydrocarbons, and
processing of the mixture in order to obtain the fuel.

3. The aircraft fuel cell system of claim 1, wherein the fuel was produced from bio oils by
extraction of oil from a biomass containing oil,
processing of the oil by catalytic hydrocracking, hydration or transesterification in order to obtain a mixture of hydrocarbons, and
processing of the mixture in order to obtain the fuel.

4. The aircraft fuel cell system of claim 1, comprising a cleaning unit arranged between the reactor and the fuel cell to separate impurities contained in the generated gas that contains hydrogen.

5. The aircraft fuel cell system of claim 1, wherein the heating apparatus comprises a burner that is supplied with at least one of the synthetic fuel and impurities which were separated, by means of the cleaning unit, from the generated gas that contains hydrogen.

6. The aircraft fuel cell system of claim 1, wherein the reactor is designed to carry out steam reforming, autothermal steam reforming or catalytic partial oxidation.

7. The aircraft fuel cell system of claim 6, wherein reforming is to be carried out at a reaction temperature ranging from 500° C. to 1000° C. and at a reaction pressure ranging from 10 bar to 25 bar.

8. The aircraft fuel cell system of claim 1, wherein the reactor is designed to carry out partial dehydration.

9. The aircraft fuel cell system of claim 8, wherein reforming is to be carried out at a reaction temperature ranging from 300° C. to 500° C., and at a reaction pressure ranging from 10 bar to 25 bar.

10. The aircraft fuel cell system of claim 8, comprising a condensation device that is arranged between the reactor and the cleaning unit in order to separate the dehydrated residual fuel from the generated gas that contains hydrogen.

11. The aircraft fuel cell system of claim 10, wherein the burner is supplied with the dehydrated residual fuel.

12. The aircraft fuel cell system of claim 1, wherein at least one of the cleaning unit and the condensation device are connected to the engine in order to feed to the engine at least one of the impurities separated in the cleaning unit and the dehydrated residual fuel.

13. The aircraft fuel cell system of claim 1, wherein the fuel cell is thermally coupled to the heating apparatus in order to utilize the heat generated during operation of the fuel cell for the purpose of heating the fuel supplied to the reactor.

14. An aircraft, comprising:
an aircraft fuel cell system including a fuel tank for a fuel present in a liquid phase, a reactor for reforming fuel from the fuel tank to a gas that contains hydrogen, a heating apparatus for heating the fuel fed to the reactor, a fuel cell, a fuel feed line for feeding fuel from the fuel tank to the reactor, and an outlet line for feeding the gas that contains hydrogen from the reactor to the fuel cell,
wherein the reactor is designed for processing, as a fuel, a synthetic fuel made from biomass and the reactor is designed to carry out partial dehydration.

15.-16. (canceled)

17. A method for generating a gas containing hydrogen in an aircraft comprising:
feeding synthetic fuel, which is produced from biomass, from a fuel tank to a reactor for reforming fuel; and
reforming the synthetic fuel.

18. The method of claim 17, wherein the fuel was produced by a biomass-to-liquid method, and the method further comprises:
a) pyrolysis of the biomass in order to obtain a carbon monoxide/hydrogen mixture (synthesis gas);
b) conversion of the synthesis gas to a mixture of liquid hydrocarbons; and
c) processing of the mixture in order to obtain the fuel.

19. The method of claim 17, wherein the fuel was produced from bio oils and the method further comprises:
a) extraction of oil from a biomass containing oil;
b) processing of the oil by catalytic hydrocracking, hydration or transesterification in order to obtain a mixture of hydrocarbons; and
c) processing of the mixture in order to obtain the fuel.
